(19) United States
(12) Patent Application Publication
(10) Pub. No.: US 2006/0102421 A1
(43) Pub. Date: May 18, 2006

(54) Circular chambered rope grab

(76) Inventor: Jeffrey Scott Dionne, Grand Rapids, MI (US)

Correspondence Address: Jeffrey S. Dionne, 1955 Laraway Lake Dr. SE, Grand Rapids, MI, 49546, US

(21) Appl. No.: 10/939,643

(22) Filed: Sep. 13, 2004

Related U.S. Application Data
(60) Provisional application No. 60/501,992, filed on Sep. 12, 2003.

(51) Int. Cl. A62B 1/16

(52) U.S. Cl. 182/5

(57) ABSTRACT

A circular chambered rope grab is provided for removably attachable fastening of a workman or climber to a safety line allowing mobility in a relaxed state while providing positive braking action in the event of a fall. The device includes a frame of equally spaced parallel walls and a horseshoe-shaped cross-section (i.e. ∪) merged to the back of these opposing walls. The frame allows passage for receiving a safety line in the ∪-shaped interior and the ∪-shaped interior is vertically grooved in a manner that provides low frictional resistance with the safety line during motion while achieving high frictional resistance on the safety line when brake is engaged. The device includes the frame with a levered braking arm having a braking surface, lanyard attachment point and centered additional aperture allowing a pivotal connection to the frame with the removable pivot pin. The frame and all of its components remain together with the actuating spring/safety keeper that connect the removable pivot pin with the frame and levered braking arm.

### CROSS REFERENCE TO RELATED APPLICATIONS

This application claims the benefit of U.S. provisional application Ser. No. 10/939,643 filed Sep. 13, 2004, which is incorporated herein in its entirety.

### BACKGROUND OF THE INVENTION

1. Field of the Invention

The present invention relates to a safety clamp appliance for removably attachable fastening to a safety line. In one aspect, the invention relates to a safety line housing comprising a frame that encompasses a safety line. Centered within the frame is a pivotally mounted, spring actuated, levered braking arm with braking surface, attached by a removable pivot pin to the frame. The levered braking arm has a lanyard attachment point to connect a workman or climber to a safety harness, providing a positive braking effect on the safety line in the event of a fall.

2. Description of the Related Art

Conventional safety clamp appliances, such as used by elevated workmen or climbers, offer a U-shaped frame with a smooth interior. Consequently, such safety clamp appliances create a high level of resistance, while in motion, on the safety line resulting in a restrictive movement or manipulation of the device during use. These safety appliances, as a result of the U-shaped frame with smooth interior, tend to structurally deform, stress, pinch and wear a safety line unnecessarily, subjecting the user to increased line failure risk. Additionally, such safety appliances offer less surface area tension at time of brake engagement.

To prevent these undesirable actions, users often hold the safety clamp appliances in an open hand held position to move about the line with less restrictions. However, such safety clamp appliances are prone to failure if the user impedes the braking action in time of fall, or needs use of both hands for work or climbing. Preferably, the safety clamp appliance will move about the safety line accommodating the user a free range of movement. Even so, the safety clamp appliance with its smooth surface interior creates unnecessary friction with the safety line and can be difficult or cumbersome to use. Alternatively, the safety clamp appliance user can simply allow the U-shaped appliance to pinch, jam, bind and deform the line unnecessarily during use. However, such safety clamp appliance issues can damage the line or prevent clamping with consequent potential failure and injury to persons or property.

The spring loaded ascender shown in U.S. Pat. No. 4,253,218 to Gibbs, issued Mar. 3, 1981, discloses a U-shaped cross-section, the frame interior being adapted to receive a safety rope, and a brake lever having a pivot point, a brake surface and a handle for attachment to a workman's belt. Consequently, the encasement of a circular safety line in a U-shaped frame has a tendency of deforming the safety line unnecessary between the braking lever and frame. Furthermore, the U-shaped frame does not properly encompass the circular dimension of a safety line. Consequently, the deforming action in the U-shaped frame will structurally wear, pinch and stress a safety line over time, undisclosed to the user. Furthermore, Gibbs and others failed to address or offer resolution to a frictional glide issue created from the rope's excessive contact with a smooth interior of a U-shaped frame or the need for adjustable tension of the spring's engagement with the brake. Consequently, such safety appliances are awkward, problematical to use, or consist of parts that may structurally damage the safety line.

### PRIOR ART

A search of the prior art patents developed a number of patents which are U-shaped in design, these include the following:

References Cited [Referenced By]

| | | | |
|---|---|---|---|
| 3,852,943 | December, 1974 | Healy | 24/134 R |
| 4,253,218 | March, 1981 | Gibbs | 24/134 |
| 4,542,884 | September, 1985 | Dodge, Jr. | 254/391 |
| 4,657,110 | April, 1987 | Wolner | 182/5 |
| 4,716,630 | January, 1987 | Skyba | 24/134 R |
| 4,881,662 | November, 1989 | Machal | 188/65.1 |
| 5,133,111 | July, 1992 | Brown | 24/134 R |
| 5,146,655 | September, 1992 | Gibbs | 24/134 |
| 5,664,640 | September, 1997 | Smith | 182/5 |
| 5,855,251 | January, 1999 | Deuer | 182/5 |
| 5,860,493 | January, 1999 | Cherpital | 188/65.2 |
| 5,924,522 | July, 1999 | Ostrobrod | 182/191 |
| 6,095,502 | August, 2000 | Dodge, Jr. | 254/389 |
| 6,561,313 | May, 2003 | Hewlwtt, et al. | 182/5 |
| 6,793,046 | September, 2004 | Petzl, et al. | 188/188 |

### SUMMARY OF THE INVENTION

A circular chambered rope grab for removably attachable fastening of a workman or climber to a safety line. In one aspect, the invention relates to a pair of equally spaced parallel walls having aligned apertures for the accommodation of a frame centered levered braking arm, having a generally horseshoe-shaped cross-section (i.e. ∪) merged to the bottom of these opposing walls, the ∪-shaped frame interior being adapted to allow passage for receiving a safety line. The ∪-shaped interior of the frame is grooved in a manner that provides less frictional resistance with the safety line during motion while achieving a high level of surface tension engaged. The device is comprised of the frame with apertures as outlined, a removably attachable adjustable actuating spring/safety keeper that connects at one end to a removable pivot pin by a ringed fastener moving freely until it passes through a frame aperture, held in contact within the frame by a threaded fastener and threaded aperture (enabling spring tension adjustability), moving freely until it enters the levered braking arm at a brake aperture, held in contact within the levered braking arm by a threaded fastener and threaded aperture. The levered braking arm has a braking surface, lanyard attachment point and additional aperture allowing a pivotal connection to the frame with the removable pivot pin. This braking arm connects by lanyard to a safety harness, providing a positive braking action in the event of a fall when assembled to the frame and encompassing the safety line.

### BRIEF DESCRIPTION OF THE DRAWINGS

In the drawings:

FIGS. 1-5 is a view of a safety clamp appliance according to the invention.

FIG. 6 is a view of a safety clamp appliance frame according to the invention.

FIG. 7 is a view of a safety clamp appliance levered braking arm according to the invention.

FIG. 8 is a view of a safety clamp appliances attached to the safety line and workman/climber according to the invention.

### DETAILED DESCRIPTION

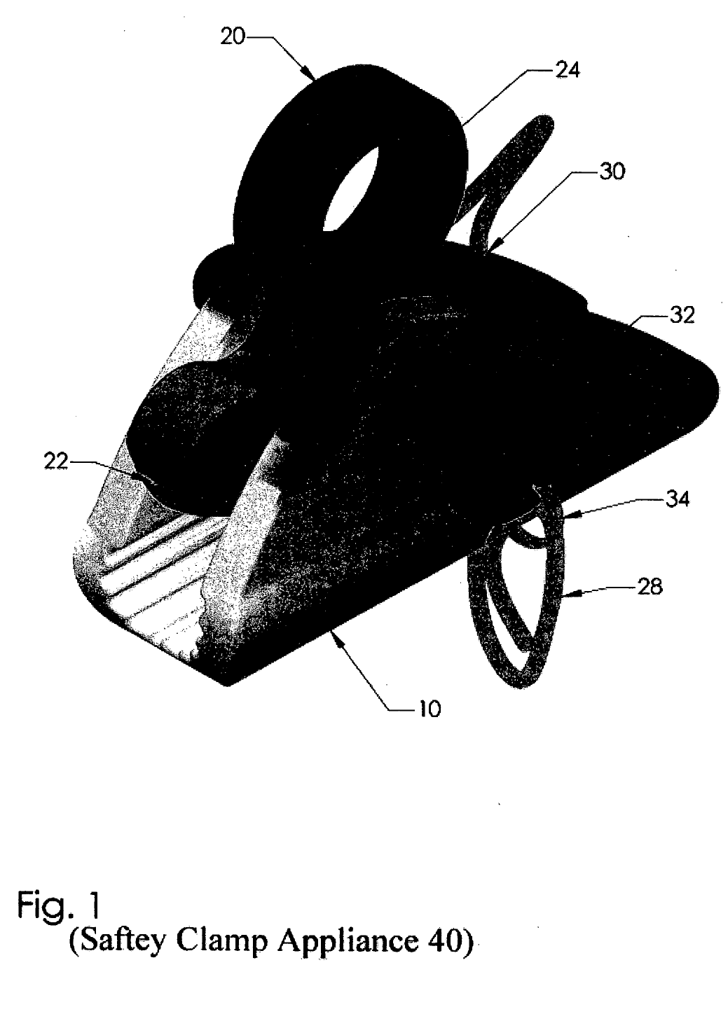

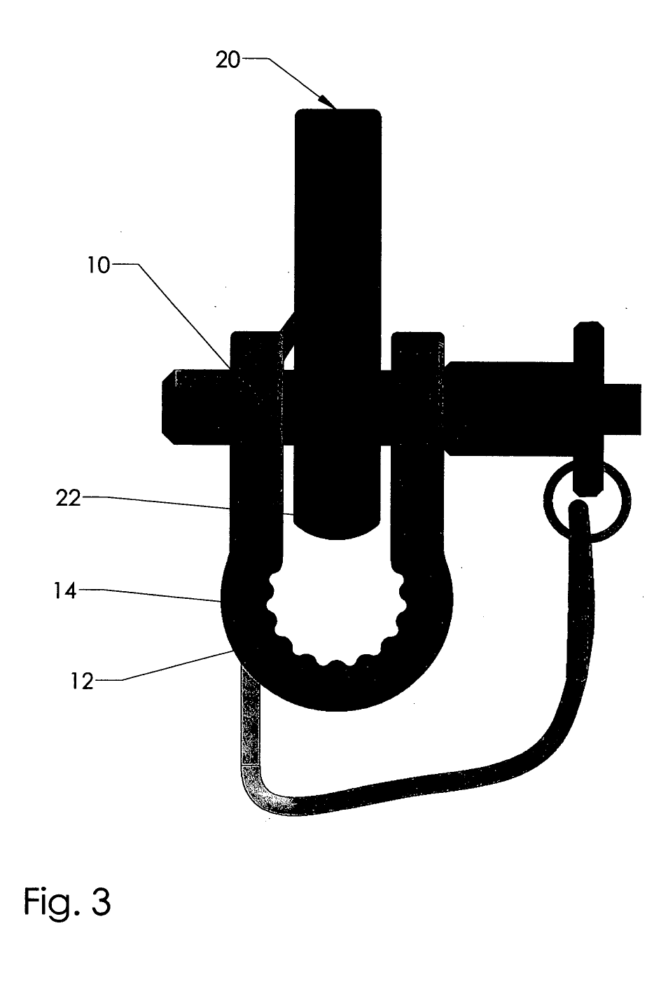

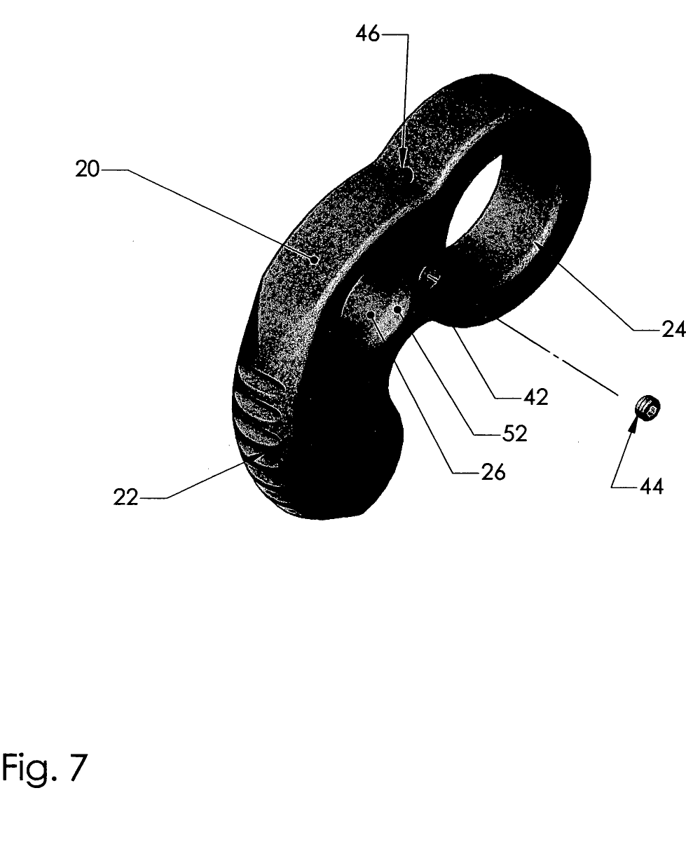

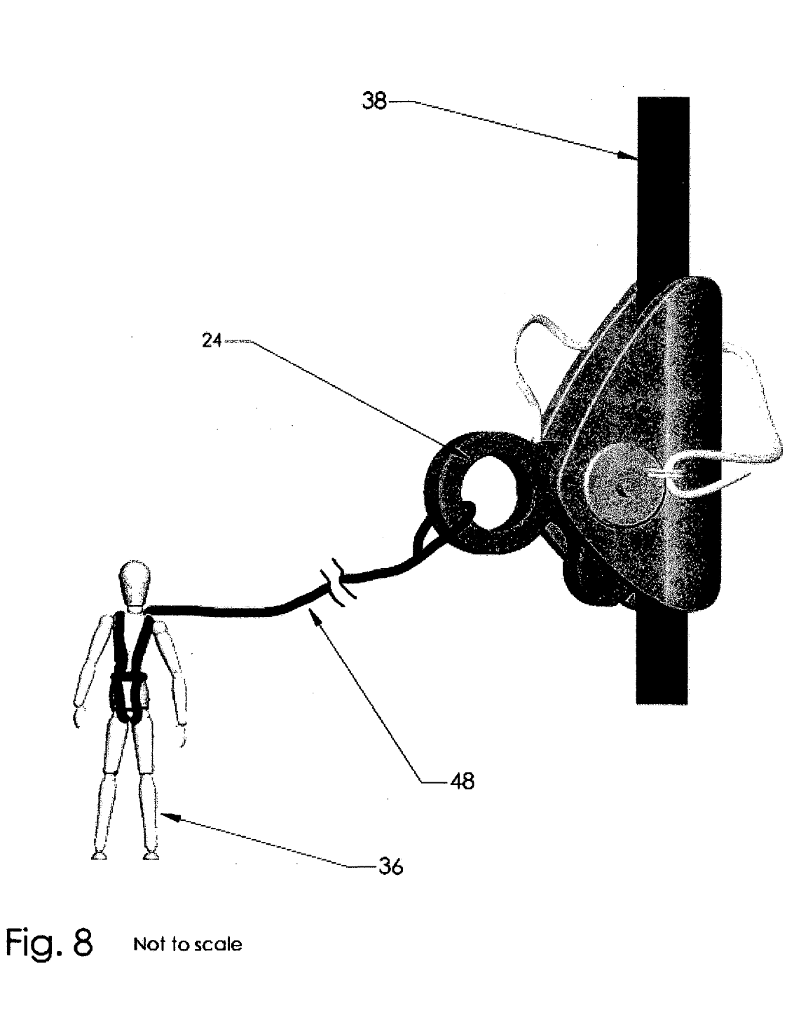

The invention comprises a movable safety clamp appliance for removably attachable fastening of a workman or mountain climber to a safety line as to arrest with a positive line braking action in the event of a fall. As shown in FIGS. 1, 3, 7, and 8, the preferred embodiment of the safety clamp appliance 40 comprises a frame 10 and a levered braking arm 20. The levered braking arm 20 is pivotally attached within the frame 10 by a removable pivot pin 32 held in alignment by way of a pivot pin aperture 26 in the frame 10 and levered braking arm 20. An actuating spring/safety keeper 28 attaches to the removable pivot pin 32 with a ringed fastener 34. This actuating spring/safety keeper 28 moves freely until it passes through a frame aperture 30, held in contact within the frame 10 by a frame threaded fastener 18 and frame threaded aperture 16 (enabling spring tension adjustability), moving freely until it enters the levered braking arm 20 at a brake aperture 46, held in contact within the levered braking arm 20 by a brake threaded fastener 44 and brake threaded aperture 42. By increasing or decreasing the actuating spring/safety keeper 28 length between the spring tension adjustment point 50 and its attachment with the levered braking arm 20 at the brake bore 46, brake engagement on the safety line 38 can be controlled. Furthermore, by connecting the actuating spring/safety keeper 28 to the levered brake arm 20, pivot pin 32 and the frame 10, loss or separation of the safety clamp appliance 40 individual components is eliminated. Additionally, this configuration allows pivot pin 32 insertions from either side of the frame 10, accommodating both the left and right hand user.

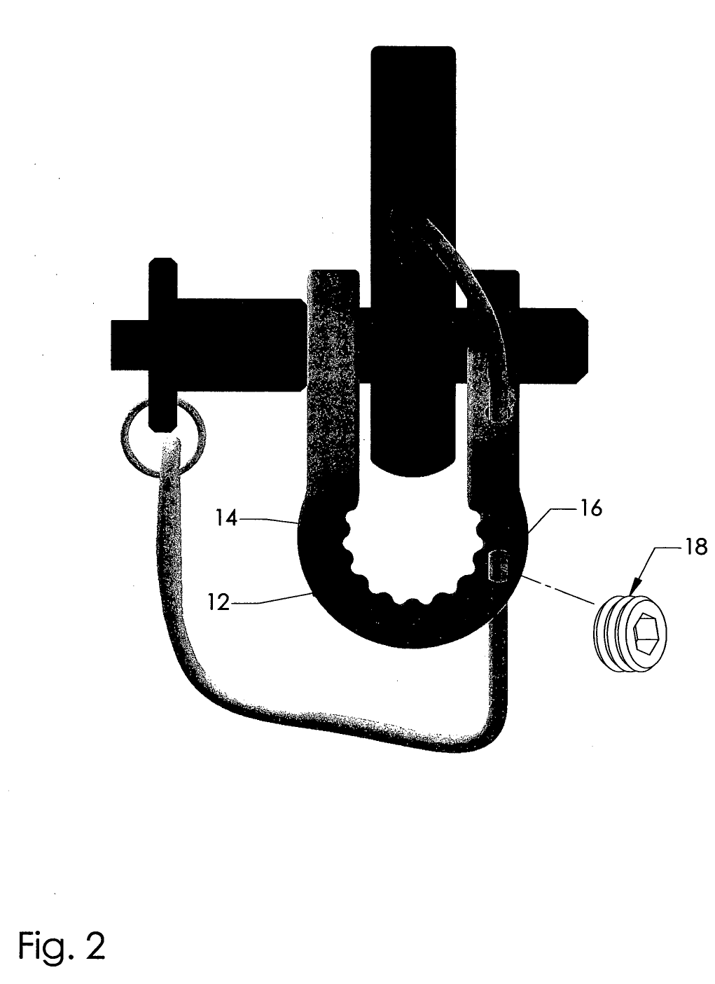

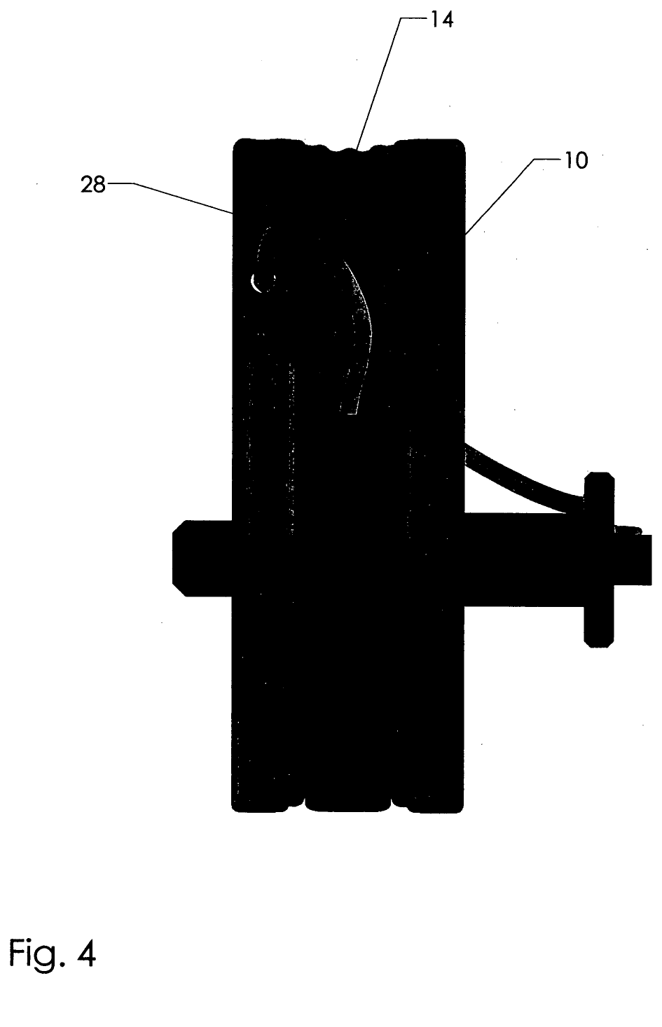

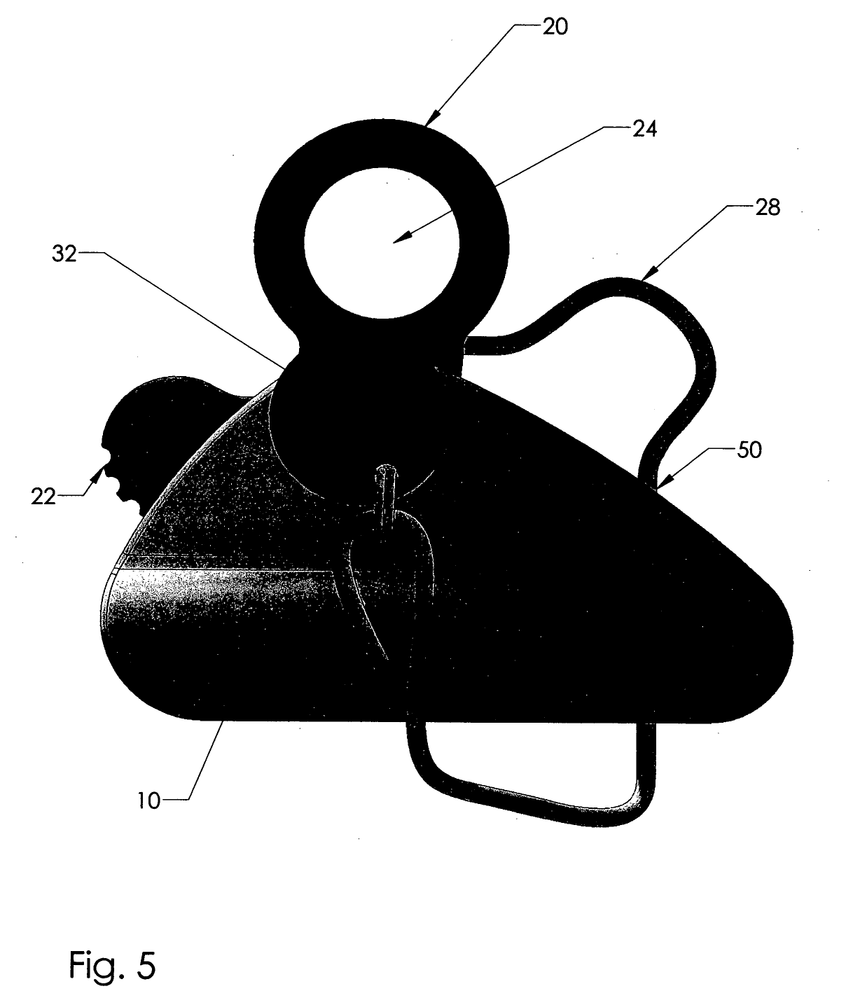

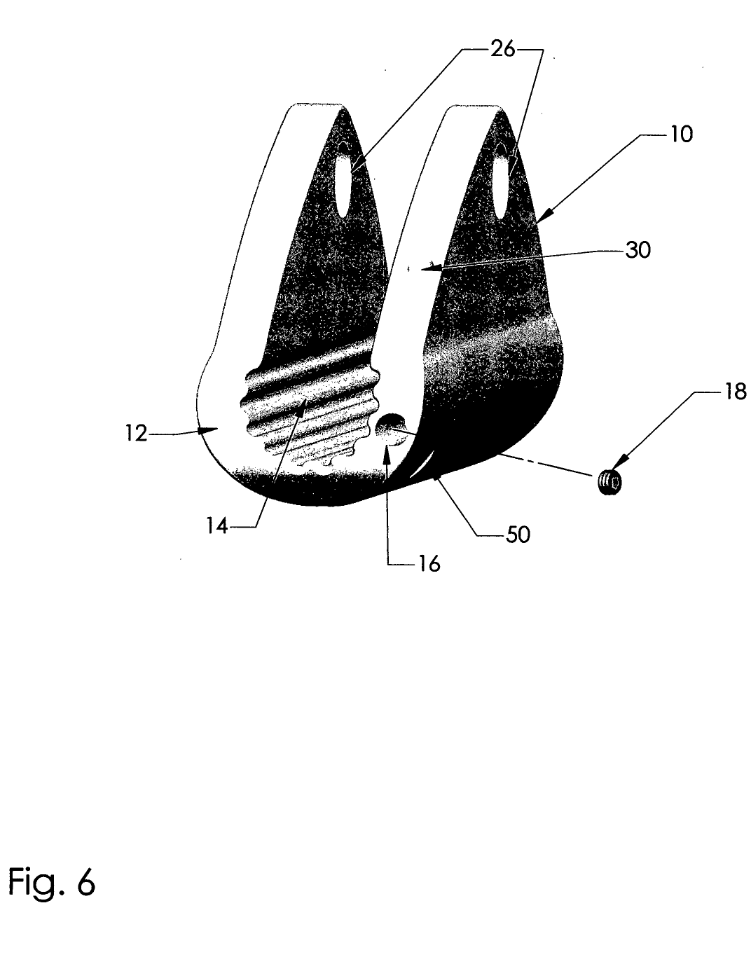

As shown in FIGS. 1, 2, 3, 4, 5, and 6, the preferred embodiment of the frame 10 comprises a pair of equally spaced parallel walls having aligned pivot pin aperture 26 for the accommodation of a frame centered levered braking arm 20, having a generally horseshoe-shaped cross-section 12 merged to the bottom of these opposing walls, providing a structure of suitable strength and configuration for the safety clamp appliance 40. The horseshoe-shaped cross-section 12 has been adapted to allow passage for receiving a safety line. Additionally, the horseshoe-shaped cross-section 12 of the frame 10 has a grooved rope chamber interior 14 that provides less frictional resistance with the safety line during motion while achieving a high level of surface tension engaged. Furthermore, the frame 10 has a frame aperture 30 allowing encased passage of the actuating spring/safety keeper 28. The frame aperture 30 is adapted to communicate with a frame threaded aperture 16 for threadably receiving a conventional frame threaded fastener 18, such as a set screw or similar threaded fastener for positive fastening of the actuating spring/safety keeper within the frame aperture 30.

As shown in FIGS. 1, 2, 3, 5, and 7, the preferred embodiment of the levered brake arm 20 begins with the braking surface 22, followed by a pivot pin aperture 26 with a chamfered lip 52, facilitating removable pivot pin 32 insertion, followed by a brake aperture 46 connecting internally to a brake threaded aperture 42 having a brake threaded fastener 44 ending at the lanyard attachment point 24. The levered braking arm 20 is pivotal attached within the frame 10 by a removable pivot pin 32 held in alignment by way of a pivot pin aperture 26 in the frame 10 and levered braking arm 20. The levered brake arm 20 has a braking surface 22 being adapted with curved crest amid ridges that communicate with the safety line upon its inward swing generating a positive braking action against the grooved rope chamber interior 12 and the braking surface 22. The forces generated on the lanyard attachment point 24 at time of arrest, while creating inward swing on the braking surface 22, create an outward movement of the levered braking arm 20. Additionally, the outward edges of the curved crest and ridges of the braking surface 22 tapered in such a manner as to prevent damage resulting from contact with the grooved rope chamber interior 12. By pivotally configuring the levered brake arm 20 above the horse shoe shaped rope chamber 12 the foundation of an optimal safety line encasement is formed. The levered braking arm 20 has a brake aperture 46 allowing encased entry of the actuating spring/safety keeper 28. The brake aperture 46 is adapted to communicate with a brake threaded aperture 42 for threadably receiving a conventional brake threaded fastener 44, such as a set screw or similar threaded fastener for positive fastening of the actuating spring/safety keeper 28 within the brake aperture 46. Lateral play between the levered braking arm 20 and the frame 10 are controlled by allotting equal space between the two. The complementary pressure of the actuating spring/safety keeper 28 upon the levered brake arm 20, develop a constant centering action upon the safety line for positive braking in time of need.

The frame 10 of the safety clamp appliance 40 is preferably fabricated of high-strength aluminum or metal blend in an assortment of colors through an extrusion process and finished on a CNC machine. Other materials and manufacturing processes can be utilized to fabricate the frame 10. For example, the frame 10 can be molded from high strength plastics, cast in grey iron or alloyed iron or CNC machined from a solid block of metal.

The levered braking arm 20 of the safety clamp appliance 40 is preferably fabricated of high-strength alloyed iron in an assortment of colors through a casting process and finished on a CNC machine. Other materials and manufacturing processes can be utilized to fabricate the levered braking arm 20. For example, the levered braking arm 20 can be molded from high strength plastics, extruded in aluminum or metal blends or CNC machined from a solid block of metal.

The actuating spring/safety keeper 28, lanyard 48, safety line 38 and removable pivot pin 32 of the safety clamp appliance 40 are common conventionally produced or acquired items that come in an array of sizes, colors and strength configurations. The actuating spring/safety keeper 28 is also known as a stainless steel cable or wire rope. The lanyard 48 is a section of nylon webbing sewn in a loop and affixed with a carabineer, quick clip or knotted to the lanyard attachment point. The safety line 38 is typically a length of kernmantle rope having a diameter of 9-13 mm manufactured of nylon, polyester or nylon/polyester blended fibers. The removable pivot pin 32 is also known as a quick releasing pin or rapid releasing pin providing a positive lock until the compression of a push button assembly allows insertion or retraction.

The novel safety clamp appliance 40 disclosed herein is a low-cost, simple, readily fabricated device for safely connecting a workman or climber 36 to a safety line 38, providing a positive braking action in the event of a fall. The safety clamp appliance 40 is a movable safety line 38 appliance for removably attachable fastening of a workman or climber 36 to a safety line 38, protecting the user from a terminal fall. The safety clamp appliance 40 can be easily attached to a safety line 38 and detached when the workman or climber 36 is no longer using the assembly disclosed herein. The horseshoe-shaped cross-section 12 of the frame 10 of the safety clamp appliance 40 has a grooved rope chamber interior 14 that provides less frictional resistance with the safety line during motion while achieving a high level of surface tension engaged. The pivotal configuration of the levered brake arm 20 above the horse shoe shaped rope chamber 12 creates the foundation of an optimal safety line encasement. By increasing or decreasing the actuating spring/safety keeper 28 length between the spring tension adjustment point 50 and its attachment with the levered braking arm 20 at the brake bore 46, brake engagement on the safety line 38 can be controlled. The complementary pressure of the actuating spring/safety keeper 28 upon the levered brake arm 20, develop a constant centering action upon the safety line for positive braking in time of need. The connection of the actuating spring/safety keeper 28 to the levered brake arm 20, pivot pin 32 and the frame 10, prevents loss or separation of the safety clamp appliance 40 individual components. The safety clamp appliance 40 allows pivot pin 32 insertions from either side of the frame 10, accommodating both the left and right hand user.

While the invention has been specifically described in connection with certain specific embodiments thereof, it is to be understood that this is by way of illustration and not of limitation, and the scope of the appended claims should be construed as broadly as the prior art will permit.

What is claimed:

1. A circular chambered rope grab, comprising:
(a) a frame;
(b) the frame comprising at least one aperture;
(c) a levered braking arm;
(d) the levered braking arm comprising at least one aperture;
(e) at least one fastener;
(f) a removable pivot pin; and
(g) an actuating spring.

2. The circular chambered rope grab of claim 1, wherein the frame having at least two generally equally spaced parallel walls.

3. The circular chambered rope grab of claim 1, wherein the frame is a generally horseshoe-shaped configuration.

4. The circular chambered rope grab of claim 1, wherein the frame is a generally c-shaped configuration.

5. The circular chambered rope grab of claim 1, wherein the frame allows passage for a vertical safety line.

6. The circular chambered rope grab of claim 1, wherein the frame comprises at least one aperture.

7. The circular chambered rope grab of claim 6, wherein at least one frame aperture is threaded.

8. The circular chambered rope grab of claim 1, wherein the levered braking arm comprises a braking surface.

9. The circular chambered rope grab of claim 1, wherein the removable pivot pin joins to the frame to the braking arm providing removably attachable fastening to a safety line.

10. The circular chambered rope grab of claim 1, wherein the adjustable actuating spring enables removable pivot pin insertion on the left and right side of said frame;

11. The circular chambered rope grab of claim 1, wherein at least one levered braking arm aperture is threaded.

12. The circular chambered rope grab of claim 1, wherein at least one fastener is threaded.

13. The circular chambered rope grab of claim 12, wherein the fastener is a setscrew.

14. The circular chambered rope grab of claim 1, wherein the actuating spring is adjustable.

15. The circular chambered rope grab of claim 1, wherein at least one fastener is inserted into the aperture enabling spring tension adjustability.

16. The circular chambered rope grab of claim 4, wherein the at least one fastener is provided for engaging a spring tension adjustment point.

17. The circular chambered rope grab of claim 1, wherein the at least one fastener is a safety keeper.

18. The circular chambered rope grab of claim 6, wherein the at least one aperture facilitates passage of the actuating spring/safety keeper.

19. The circular chambered rope grab of claim 6, wherein the at least one apertures facilitates passage of the removable pivot pin.

20. The circular chambered rope grab of claim 1, wherein the frame has a generally larger diameter than a rope diameter.

21. The circular chambered rope grab of claim 1, wherein the frame is aligned generally vertical on a vertically extended safety line having generally a top and bottom alignment for the accommodation of a frame centered levered braking arm and generally horizontally inserted pivot pin.

22. The circular chambered rope grab of claim 1, wherein the levered brake arm comprises a braking surface tailored with at least one curved crest amid at least one ridge.

23. The circular chambered rope grab of claim 22, wherein at least one braking surface ridge communicates with the safety line upon its inward swing generating a positive braking action against the braking surface and the frame interior.

24. The circular chambered rope grab of claim 1, wherein a ringed fastener attached to said removable pivot pin that connects to said actuating spring.

25. The circular chambered rope grab of claim 1, wherein the brake is pivotally attached within the frame by a removable pivot pin held in alignment by way of the aperture.

26. A circular chambered rope grab, comprising:
(a) a frame;
(b) a frame having a generally horseshoe-shaped configuration;
(c) a levered braking arm;
(d) a removable pivot pin that joins to said frame to said braking arm providing removably attachable fastening to a safety line;
(e) an adjustable actuating spring, enabling insertion of the removable pivot pin on the left and right side of said frame; and
(f) a ringed fastener attached to said removable pivot pin that connects to said adjustable actuating spring.

27. The circular chambered rope grab of claim 26, wherein the frame comprises at least one aperture.

28. The circular chambered rope grab of claim 27, wherein the spring moves freely from its connection with said removable pivot pin until it passes through a frame aperture.

29. The circular chambered rope grab of claim 27, wherein at least one frame aperture is a threaded aperture.

30. The circular chambered rope grab of claim 26, wherein the rope grab includes at least one fastener.

31. The circular chambered rope grab of claim 30, wherein at least one fastener is threaded.

32. The circular chambered rope grab of claim 31, wherein the spring is held in contact within the frame by the threaded fastener in the threaded aperture thus enabling spring tension adjustability.

33. The circular chambered rope grab of claim 32, the spring moving freely until it enters the levered braking arm at a brake aperture, held in contact within the levered braking arm by a threaded fastener in a threaded aperture.

34. The circular chambered rope grab of claim 31, wherein at least one fastener is a setscrew.

35. The circular chambered rope grab of claim 31, wherein the at least one fastener is inserted into the aperture.

36. The circular chambered rope grab of claim 30, wherein the at least one fastener is provided thereof for engaging the actuating spring/safety keeper.

37. The circular chambered rope grab of claim 30, wherein the at least one fastener is provided thereof for engaging the spring tension adjustment point.

38. The circular chambered rope grab of claim 27, wherein the at least one aperture facilitates passage of the actuating spring/safety keeper.

39. The circular chambered rope grab of claim 27, wherein the at least one aperture facilitates passage of the removable pivot pin.

40. The circular chambered rope grab of claim 26, wherein the frame has a generally larger diameter than a rope diameter.

41. The circular chambered rope grab of claim 26, wherein the frame comprises at least one vertical groove.

42. The circular chambered rope grab of claim 41, wherein the frame groove is tailored with at least one curved crest.

43. The circular chambered rope grab of claim 42, wherein the frame groove crest provides low frictional resistance with the safety line during motion, achieving high frictional resistance on the safety line when brake is engaged.

44. The circular chambered rope grab of claim 26, wherein the braking arm comprises at least one braking surface.

45. The circular chambered rope grab of claim 44, wherein the braking surface comprises a vertical groove tailored with at least one curved crest.

46. The circular chambered rope grab of claim 45, wherein the surface crest provides a constant centering action upon the safety line.

47. The circular chambered rope grab of claim 26, wherein the braking arm comprises at least aperture.

48. The circular chambered rope grab of claim 47, wherein the at least one braking arm aperture is threaded.

49. The circular chambered rope grab of claim 47, wherein the at least one fastener is inserted into the braking arm aperture.

50. The circular chambered rope grab of claim 47, wherein the brake is pivotal attached within the frame by a removable pivot pin held in alignment by way of the braking arm aperture.
